(19) United States
(12) Patent Application Publication
(10) Pub. No.: US 2024/0310493 A1
(43) Pub. Date: Sep. 19, 2024

(54) OPTICAL DEVICE AND METHOD FOR CONTROLLING OPTICAL DEVICE

(71) Applicant: NEC Corporation, Minato-ku, Tokyo (JP)

(72) Inventor: Takahiro Ono, Tokyo (JP)

(73) Assignee: NEC Corporation, Minato-ku, Tokyo (JP)

(21) Appl. No.: 18/268,544

(22) PCT Filed: Mar. 25, 2021
(86) PCT No.: PCT/JP2021/012455

§ 371 Date: Jun. 20, 2023

(51) Int. Cl. G01S 7/481

(52) U.S. Cl. CPC G01S 7/4818

(57) ABSTRACT

[Problem] To provide an optical device and a method for controlling said optical device which enable more accurate measurement by using LiDAR.

[Solution] This optical device is provided with: a first reflection means that reflects light emitted from a light emission means and irradiates an object with the reflected light as irradiation light; and a second reflection means that reflects the irradiation light reflected by the object toward a light reception means. The irradiation light reflected by the first reflection means passes through an opening part provided for the second reflection means and is applied to the object.

### TECHNICAL FIELD

The present invention relates to an optical device that enables more accurate measurement by using light detection and ranging (LiDAR), and a method for controlling the optical device.

### BACKGROUND ART

In recent years, a technology called LiDAR has been used in which light is emitted onto a target object and a surface condition and the like of the target object are detected based on reflected light received from the target object. For example, a technique for measurement using LiDAR is disclosed in PTL 1.

### CITATION LIST

### Patent Literature

PTL 1: Japanese Unexamined Patent Application Publication No. 2021-004888

### SUMMARY OF INVENTION

### Technical Problem

In LiDAR, a configuration in which a transmission optical system that emits light and a reception optical system that receives reflected light from a target object are integrated may be used. In this configuration, the light emitted from the transmission optical system and the reflected light received by the reception optical system enter the same lens.

In this case, since the reception optical system receives not only the reflected light from the target object but also light reflected by the lens after being emitted from the transmission optical system, intensity of the reflected light from the target object may not be accurately detected.

The present invention is made in view of the above-described problem, and an object of the present invention is to provide an optical device capable of more accurate measurement using LiDAR, and a method for controlling the optical device.

### Solution to Problem

An optical device according to the present invention includes
a first reflection means for reflecting light emitted from a light emission means and irradiating the light onto an object, as collimated irradiation light, and
a second reflection means for reflecting, toward a light reception means, the irradiation light reflected by the object, and
the irradiation light reflected by the first reflection means passes through an opening part being provided for the second reflection means and irradiates the object.

A method for controlling an optical device according to the present invention includes
reflecting light emitted from a light emission means and irradiating the light onto an object, as collimated irradiation light,
causing irradiation light reflected by the first reflection means to pass through an opening part being provided for the second reflection means, and
reflecting, toward a light reception means, the irradiation light reflected by the object.

### Advantageous Effects of Invention

According to the present invention, it is possible to provide an optical device capable of accurate measurement using LiDAR, and a method for controlling the optical device.

### BRIEF DESCRIPTION OF DRAWINGS

FIG. 1 is a schematic diagram illustrating an optical device according to a first example embodiment of the present invention.

FIG. 2 is a diagram for describing an operation of the optical device according to the first example embodiment of the present invention.

FIG. 3 is a diagram illustrating a configuration example of a modification example of the optical device according to the first example embodiment of the present invention.

FIG. 4 is a block diagram illustrating a configuration example of an optical device according to a second example embodiment of the present invention.

FIG. 5 is a flowchart illustrating an operation example of the optical device according to the second example embodiment of the present invention.

### EXAMPLE EMBODIMENT

### First Example Embodiment

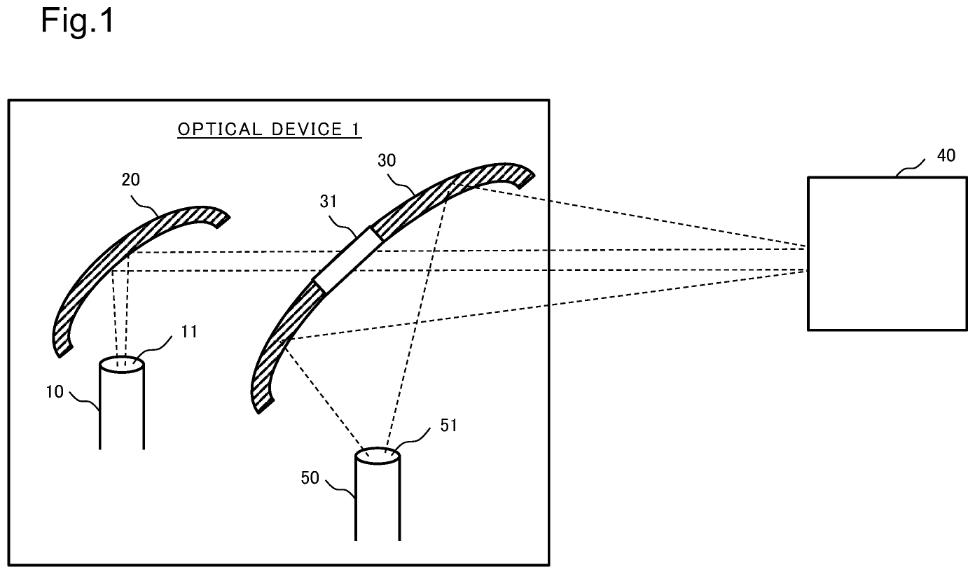

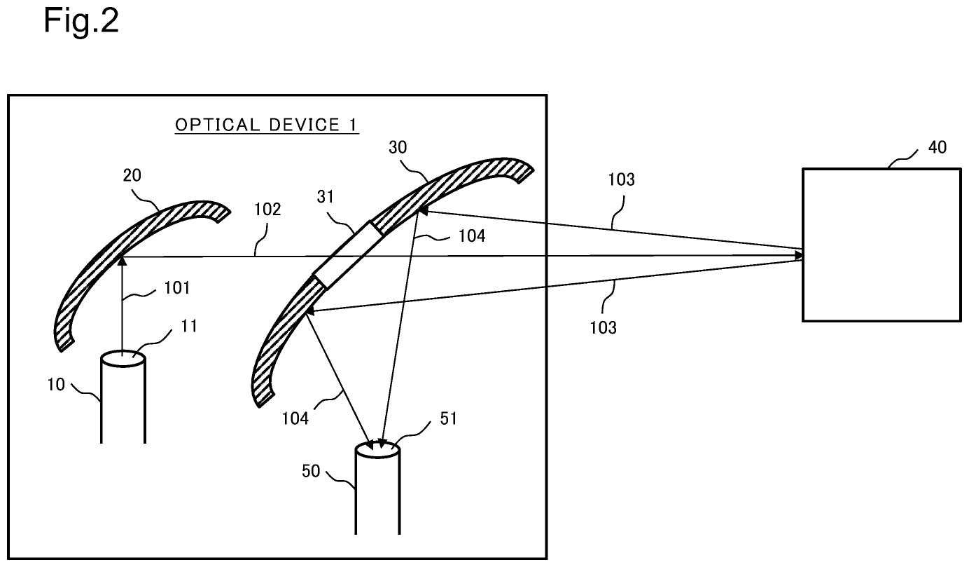

An optical device 1 according to a first example embodiment is described based on FIGS. 1 and 2. FIG. 1 is a schematic diagram illustrating a configuration example of the optical device 1. Further, FIG. 2 is a diagram illustrating an operation example of the optical device 1.

As illustrated in FIG. 1, the optical device 1 includes a first optical fiber 10, a first reflection means 20, a second reflection means 30, and a second optical fiber 50. Further, light emitted from the optical device 1 irradiates a target object 40, and reflected light from the target object 40 is received. Further, a dotted line illustrated in FIG. 1 indicate an optical path of the light. Further, the first optical fiber 10 corresponds to a light emission means. Further, the second optical fiber 50 corresponds to a light reception means. Note that, the first optical fiber 10, the first reflection means 20, the second reflection means 30, and the second optical fiber 50 may be accommodated in the same housing.

The first optical fiber 10 emits light output from an unillustrated light source from an emission surface 11. The light emitted from the first optical fiber 10 enters the first reflection means 20. The light is, for example, pulsed laser light. The emission surface 11 is a core of an end surface of the first optical fiber 10.

The first reflection means 20 reflects the light output from the first optical fiber 10, and irradiates collimated light onto an object. Specifically, the light reflected by the first reflection means 20 is turned into collimated light, and is incident on the target object 40 after passing through an opening part 31, which is described later. The first reflection means 20 is, for example, a reflective-type collimator. Note that, the first reflection means 20 may not be a reflective-type collimator, and may be configured of a mirror and a collimator lens. In this case, as illustrated in FIG. 1, the first reflection means 20 emits collimated light toward the opening part 31 by reflecting light from the first optical fiber 10 with the mirror and passing the light reflected by the mirror through the collimator lens, instead of reflecting light and emitting collimated light by using one optical component.

The second reflection means 30 includes the opening part 31. The second reflection means 30 passes the light reflected by the first reflection means 20 through the opening part 31. Further, the second reflection means 30 reflects, toward the second optical fiber 50, reflected light resulting from reflection of light irradiated from the first reflection means 20 at the target object 40. At this occasion, the second reflection means 30 condenses the reflected light from the target object 40 and causes the reflected light to enter the second optical fiber 50. The second reflection means 30 is, for example, a parabolic mirror capable of condensing the reflected light. The opening part 31 is an aperture formed on the second reflection means 30.

Note that, the second reflection means 30 is placed in a position at which the reflected light from the first reflection means 20 passes through a central part of the opening part 31. Thereby, even when an angle of the first reflection means 20 shifts slightly or a position of the second reflection means 30 shifts, the reflected light from the first reflection means 20 can pass through the opening part 31.

The second optical fiber 50 receives, with a light reception surface 51, light that is the reflected light from the target object 40 and is reflected by the second reflection means 30. The second optical fiber 50 outputs the received light to an unillustrated photodetector. The light reception surface 51 is a core of an end surface of the second optical fiber 50.

Next, an operation of the optical device 1 is described with reference to FIG. 2. Arrows 101 to 104 in FIG. 2 are for describing the operation of the optical device 1.

As indicated by the arrow 101, the first optical fiber 10 emits light to the first reflection means 20. As indicated by the arrow 102, the first reflection means 20 collimates the light from the first optical fiber 10, and reflects the collimated light toward the target object 40. At this occasion, the collimated light emitted from the first reflection means 20 is incident on the target object 40 via the opening part 31 of the second reflection means 30. As indicated by the arrow 103, the collimated light that is incident on the target object 40 is reflected by a surface of the target object 40, and enters a second reflection means 40. As indicated by the arrow 104, the second reflection means 30 emits the reflected light that has entered from the target object 40 toward the light reception means 50.

As described above, in the optical device 1, light reflected by the first reflection means 20 is output as collimated light. Therefore, the optical device 1 does not require an optical component for collimating light, such as a collimator lens, at a stage later than the first reflection means 20. Further, since the collimated light irradiating the target object 40 passes through the opening part of the second reflection means 30, the collimated light does not enter the second reflection means, which the reflected light from the target object enters. Therefore, according to the optical device 1, light output to the unillustrated photodetector via the second optical fiber 50 is unlikely to contain the collimated light irradiating the target object. Consequently, the optical device 1 can cause the photodetector and the like to accurately detect an intensity of reflected light from the target object.

Since the optical device 1 includes the first reflection means 20, a position of the first optical fiber 10 can be freely changed by adjusting an angle of the first reflection means 20. For example, in a case in which the first reflection means 20 is not provided, the position of the optical fiber 10 with respect to the opening part 31 is limited in order to allow light irradiating the target object 40 to pass through the opening part 31. However, by providing the first reflection means 20, it is possible to install the first optical fiber in such a way that the emission surface 11 of the first optical fiber 10 becomes parallel to the light reception surface 51 of the second optical fiber, as illustrated in FIG. 1. In this case, since the first optical fiber 10 and the second optical fiber 50 extend toward the same direction, it is possible to hold the first optical fiber 10 and the second optical fiber 50 with the same holding member placed in the direction in which the first optical fiber 10 and the second optical fiber 50 extend. Therefore, the configuration of the optical device 1 can be simplified compared to a case in which the first optical fiber 10 and the second optical fiber 50 are held by separate holding members.

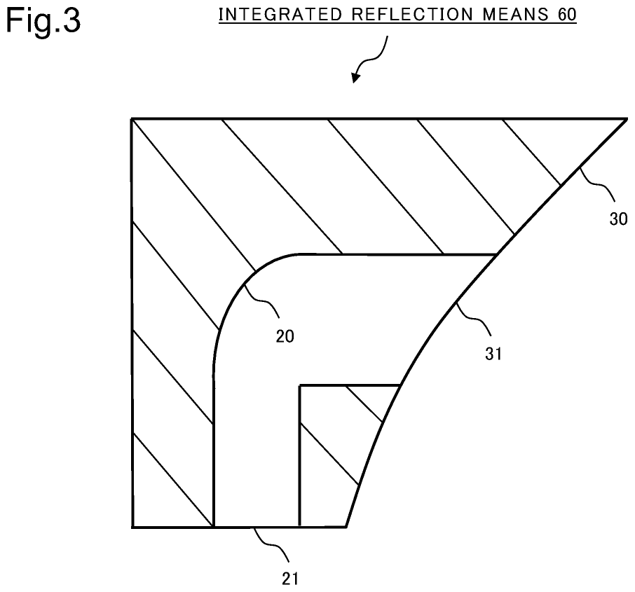

Note that, in the description of FIG. 1, the first reflection means 20 and the second reflection means 30 are described as separate optical components, but the first reflection means 20 and the second reflection means 30 may be provided integrally. FIG. 3 is a schematic diagram illustrating an integrated reflection means 60 in which the first reflection means 20 and the second reflection means 30 are integrated. The integrated reflection means 60 includes the first reflection means 20 and the second reflection means 30. Further, the second reflection means 30 includes the opening part 31, as in FIG. 1. The integrated reflection means 60 further includes an opening part 21.

In the integrated reflection means 60, light emitted from the first optical fiber 10 passes through the opening part 21, is reflected by the first reflection means 20, and irradiates the target object 40. Reflected light from the target object 40 is further reflected by the second reflection means 30 and received by the second optical fiber 50, as in FIG. 1.

### Second Example Embodiment

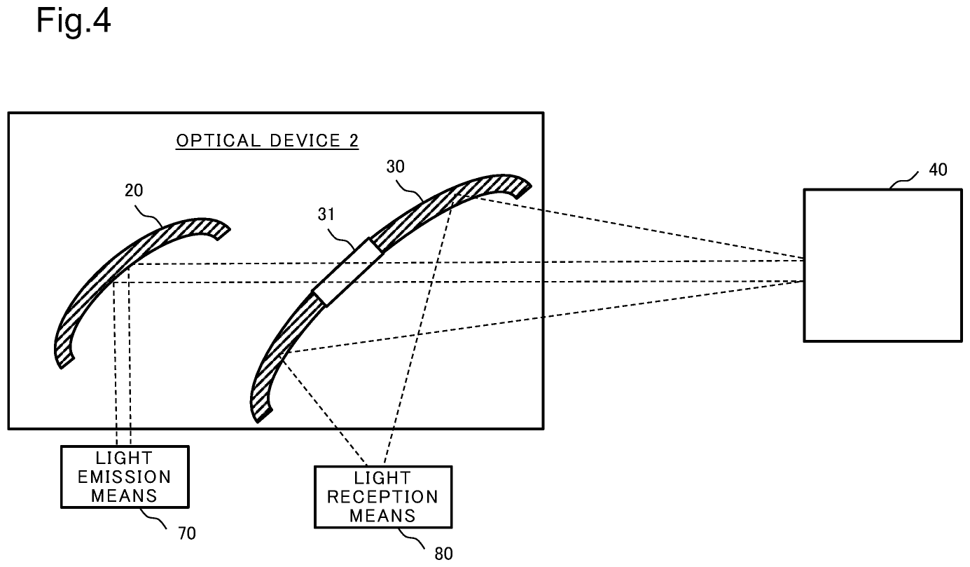

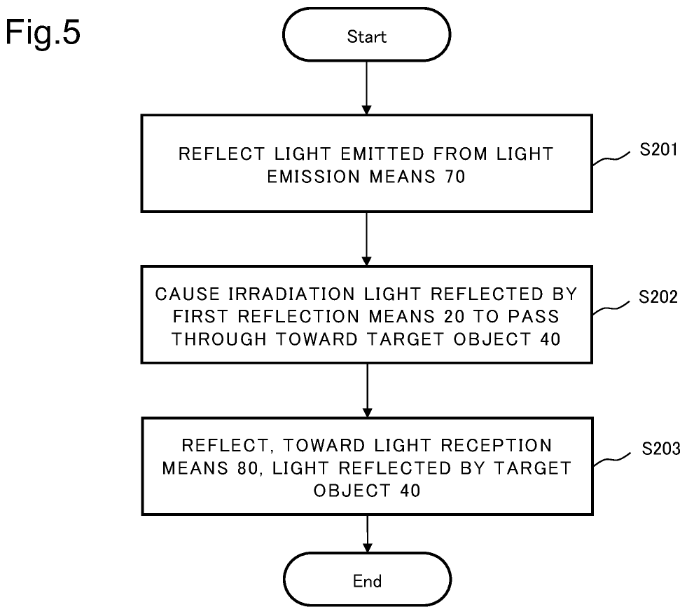

An optical device 2 according to a second example embodiment is described based on FIGS. 4 and 5. The optical device 2 includes, as illustrated in FIG. 4, a first reflection means 20 and a second reflection means 30. Further, a target object 40, a light emission means 70, and a light reception means 80 are located outside the optical device 2. Note that, the optical device 2 may include at least one of the light emission means 70 and the light reception means 80.

The first reflection means 20 reflects light emitted from the light emission means 70 and irradiates collimated light onto an object. The first reflection means 20 may have a function and a connection relationship similar to those of the first reflection means 20 of the above-described optical device 1.

The second reflection means 30 reflects, toward the light reception means 80, reflected light resulting from reflection of the collimated light at the target object 40. The second reflection means 30 may have a function and a connection relationship similar to those of the second reflection means 30 of the above-described optical device 1.

In the optical device 2, the collimated light irradiated by the first reflection means 20 passes through the opening part 31 provided for the second reflection means 30 and is incident on the target object 40.

Note that, the light emission means 70 may be an optical fiber, or a light source such as a laser. Further, the light reception means 80 may be an optical fiber, or a photodetector such as a photo diode (PD).

Next, an operation of the optical device 2 is described based on FIG. 5.

The first reflection means 20 reflects light emitted from the light emission means 70, and irradiates collimated light onto an object (S201). The opening part 31 allows the collimated light irradiated by the first reflection means 20 to pass through toward the target object 40 (S202). The second reflection means 30 reflects, toward the light reception means 80, reflected light resulting from reflection of the collimated light at the target object 40 (S203).

In this way, in the optical device 2, light reflected by the first reflection means 20 is output as collimated light. Therefore, the optical device 2 does not require an optical component for collimating light, such as a collimator lens, at a stage later than the first reflection means 20. Further, since the collimated light irradiating the target object passes through the opening part of the second reflection means 30, the collimated light does not enter the second reflection means 30, which reflected light from the target object enters. Therefore, according to the optical device 2, light output to an unillustrated photodetector via the second optical fiber 50 is unlikely to contain the collimated light irradiating the target object. Consequently, the optical device 2 can cause the photodetector and the like to accurately detect an intensity of the reflected light from the target object.

Further, since the optical device 2 includes the first reflection means 20, a position of the light emission means can be freely changed by adjusting an angle of the first reflection means 20. Therefore, similarly to the optical device 1, a configuration of the optical device 2 can be simplified.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1,2 Optical device
10 First optical fiber
11 Emission surface
20 First reflection means
30 Second reflection means
21, 31 Opening part
40 Target object
50 Second optical fiber
51 Light reception surface
60 Integrated reflection means
70 Light emission means
80 Light reception means

What is claimed is:

1. An optical device comprising:
a first reflector configured to reflect light emitted from a light emitter and irradiate collimated light onto an object; and
a second reflector configured to reflect, toward a light receiver, reflected light resulting from reflection of the collimated light at the object, wherein
collimated light irradiated by the first reflector passes through an opening part provided the second reflector and is incident on the object.

2. The optical device according to claim 1, wherein the first reflector causes the collimated light to pass through a center part of the opening part.

3. The optical device according to claim 1, wherein the first reflector and the second reflector are accommodated in a same housing.

4. The optical device according to claim 1, wherein the light emitted from the light emitter is a pulse wave.

5. The optical device according to claim 1, wherein the light emitter is an end surface of a first optical fiber, and
the light receiver is an end surface of a second optical fiber.

6. The optical device according to claim 5, wherein the first optical fiber and the second optical fiber are installed in parallel to each other.

7. A controlling method for an optical device, comprising:
reflecting light emitted from a light emitter by a first reflector and irradiating collimated light onto an object;
causing the collimated light irradiated by the first reflector to pass through an opening part provided for a second reflector; and
reflecting, by the second reflector, reflected light resulting from reflection of the collimated light at the object, toward a light receiver.

8. The optical device according to claim 2, wherein the first reflector and the second reflector are accommodated in a same housing.

9. The optical device according to claim 2, wherein the light emitted from the light emitter is a pulse wave.

10. The optical device according to claim 3, wherein the light emitted from the light emitter is a pulse wave.

11. The optical device according to claim 2, wherein the light emitter is an end surface of a first optical fiber, and
the light receiver is an end surface of a second optical fiber.

12. The optical device according to claim 3, wherein the light emitter is an end surface of a first optical fiber, and
the light receiver is an end surface of a second optical fiber.

13. The optical device according to claim 4, wherein the light emitter is an end surface of a first optical fiber, and
the light receiver is an end surface of a second optical fiber.
